(19) United States
(12) Patent Application Publication
(10) Pub. No.: US 2023/0332629 A1
(43) Pub. Date: Oct. 19, 2023

(54) MODULE HAVING OIL CLEANING FUNCTION FOR DIAGNOSING INTEGRITY OF ACTUATOR

(71) Applicant: Kye Cheon YOUN, Busan (KR)

(72) Inventor: Kye Cheon YOUN, Busan (KR)

(21) Appl. No.: 17/918,914

(22) PCT Filed: Apr. 19, 2021
(86) PCT No.: PCT/KR2021/004900

§ 371 Date: Oct. 14, 2022

(30) Foreign Application Priority Data
Apr. 22, 2020 (KR) 10-2020-0048709

(51) Int. Cl. F15B 19/00; F15B 13/02

(52) U.S. Cl. CPC F15B 19/005; F15B 13/02

(57) ABSTRACT

An integrity diagnosis module of an actuator with an oil cleaning function is provided. The integrity diagnosis module of an actuator with an oil cleaning function includes at least one of a driving module coupled at a driving valve position of the actuator and configured to supply oil for a cleaning function of the actuator or an integrity diagnosis function of the actuator to a cylinder hydraulic chamber provided to the actuator or to recover the oil from the cylinder hydraulic chamber provided to the actuator; and an emergency module coupled at an emergency stop valve position of the actuator and configured to supply the oil to a dump hydraulic chamber provided to the actuator or to recover the oil from the dump hydraulic chamber provided to the actuator.

### CROSS REFERENCE TO THE RELATED APPLICATIONS

This application is the national phase entry of International Application No. PCT/KR2021/004900, filed on Apr. 19, 2021, which is based upon and claims priority to Korean Patent Application No. 10-2020-0048709, filed on Apr. 22, 2020, the entire contents of which are incorporated herein by reference.

### TECHNICAL FIELD

The present invention relates to an integrity diagnosis module of an actuator with an oil cleaning function, and more particularly, to an integrity diagnosis module of an actuator with an oil cleaning function that may implement an oil cleaning function of an actuator through coupling at a valve position of the actuator and also implement an integrity diagnosis function of the actuator without a need to replace a module.

### BACKGROUND

Output of a turbine that produces electricity in a power plant is regulated depending on whether steam is supplied or shut off. In detail, supply and shut-off of the steam to the turbine is performed by opening or closing an opening through which the steam is supplied to the turbine through an opening and closing operation of a turbine valve.

In channels in an actuator, hydraulic oil with foreign substances may flow or foreign substances floating in the hydraulic oil may be attached to an inner wall of a pipe that forms a channel according to an operation of the actuator, thereby affecting reliability on the operation of the actuator and further adversely affecting an operation of the turbine valve.

To implement an oil cleaning function of an actuator, the prior art (Korean Patent Registration No. 10-1657619) couples a flushing unit at a valve position of the actuator and removes an element such as foreign substances attached to an inner wall of a pipe and a cylinder.

However, considering characteristics of the actuator, in the prior art, if the oil cleaning function of the actuator is implemented, the flushing unit needs to be replaced as a separate diagnosis unit at the valve position of the actuator for integrity diagnosis of the actuator. If an integrity diagnosis function of the actuator is implemented, the diagnosis unit needs to be replaced with a corresponding valve of the actuator at the valve position of the actuator. Therefore, a replacement work needs to be performed at least three times and accordingly, there is an issue in that a working time and working cost increases according to performing the replacement work at least three times.

Also, leakage oil needs to be treated at least three times according to the replacement work and accordingly, there is an issue in that a treatment time and treatment cost according to treatment of leakage oil at least three times.

The related art is disclosed in Korean Patent Registration No. 10-1657619 (titled flushing unit of hydraulic actuator for power plant, announced on Sep. 19, 2016).

### SUMMARY

### Object

The present invention is conceived to solve the aforementioned issues, and provides an integrity diagnosis module of an actuator with an oil cleaning function that may implement an oil cleaning function of an actuator through coupling at a valve position of the actuator and also implement an integrity diagnosis function of the actuator without a need to replace a module.

### Solution

According to an example embodiment to accomplish the aforementioned purposes of the present invention, an integrity diagnosis module of an actuator with an oil cleaning function according to the present invention includes at least one of a driving module coupled at a driving valve position of the actuator and configured to supply oil for a cleaning function of the actuator or an integrity diagnosis function of the actuator to a cylinder hydraulic chamber provided to the actuator or to recover the oil from the cylinder hydraulic chamber provided to the actuator; and an emergency module coupled at an emergency stop valve position of the actuator and configured to supply the oil to a dump hydraulic chamber provided to the actuator or to recover the oil from the dump hydraulic chamber provided to the actuator.

Here, the driving module includes a driving body including a driving block in a hexahedral shape, at least one of a driving A1 port and a driving B1 port that are spaced apart from each other on a driving 1 surface of the driving block, a driving P1 port and a driving T1 port, at least one of a driving A2 port and a driving B2 port that are spaced apart from each other on a driving 2 surface of the driving block facing the driving 1 space, a driving P2 port and a driving T2 port, at least one of a driving A channel (that connects the driving A1 port and the driving A2 port) and a driving B channel (that connects the driving B1 port and the driving B2 port), a driving P channel that connects the driving P1 port and the driving P2 port, and a driving T channel that connects the driving T1 port and the driving T2 port; and a driving control valve coupled to the driving 2 surface and configured to deliver oil delivered to the driving P2 port to the driving A2 port or the driving B2 port, or to deliver oil delivered to the driving A2 port or the driving B2 port to the driving T2 port.

Here, the driving body further includes a driving branch P channel that branches from the driving P channel and a driving branch P port provided to the outer circumference of the driving body and to which the driving branch P channel is connected, the driving module further includes a driving quick coupler coupled to the driving branch P port and configured to prevent the oil delivered to the driving P channel from flowing back toward the driving branch P port, and the oil that is supplied to the cylinder hydraulic chamber is supplied from the driving P1 port or the driving quick coupler.

An integrity diagnosis module of an actuator with an oil cleaning function according to the present invention includes a driving module coupled at a driving valve position of the actuator and configured to supply oil for a cleaning function of the actuator or an integrity diagnosis function of the actuator to a cylinder hydraulic chamber of the actuator or to recover the oil from the cylinder hydraulic chamber provided to the actuator; and an opening and closing module coupled at an opening and closing valve position of the actuator and configured to determine whether to deliver the oil to the driving module.

Here, the opening and closing module includes an opening and closing body including an opening and closing block in a hexahedral shape, an opening and closing A1 port and an opening and closing B1 port that are spaced apart from each other on an opening and closing 1 surface of the opening and closing block, an opening and closing A2 port provided to one of an opening and closing side surface of the opening and closing block that is connected to the opening and closing 1 surface and an opening and closing 2 surface of the opening and closing block that faces the opening and closing 1 surface, an opening and closing B2 port provided to one of the opening and closing side surface of the opening and closing block that is connected to the opening and closing 1 surface and the opening and closing 2 surface of the opening and closing block that faces the opening and closing 1 surface, an opening and closing A channel that connects the opening and closing A1 port and the opening and closing A2 port, and an opening and closing B channel that connects the opening and closing B1 port and the opening and closing B2 port; and an opening and closing line configured to connect the opening and closing A2 port and the opening and closing B2 port.

Here, the opening and closing body further includes an opening and closing branch B channel that branches from the opening and closing B channel and an opening and closing branch B port provided to the other one of the opening and closing side surface of the opening and closing block that is connected to the opening and closing 1 surface and the opening and closing 2 surface of the opening and closing block that faces the opening and closing 1 surface and to which the opening and closing branch B channel is connected, the opening and closing module further includes an opening and closing quick coupler coupled to the opening and closing branch B port and configured to prevent the oil delivered to the opening and closing B channel from flowing back toward the opening and closing branch B port, and the oil that is supplied to the driving module is supplied from the opening and closing A1 port or the opening and closing quick coupler.

Here, the opening and closing module includes an opening and closing body including an opening and closing block in a hexahedral shape, an opening and closing A1 port and an opening and closing B1 port that are spaced apart from each other on an opening and closing 1 surface of the opening and closing block, an opening and closing A channel that is connected to the opening and closing A1 port, an opening and closing B channel that is connected to the opening and closing B1 port, and a connection channel that connects the opening and closing A channel and the opening and closing B channel.

Here, the opening and closing body further includes an opening and closing branch channel that branches from one of the opening and closing A channel, the opening and closing B channel, and the connection channel, and an opening and closing branch port provided to one of an opening and closing side surface of the opening and closing block that is connected to the opening and closing 1 surface and an opening and closing 2 surface of the opening and closing block facing the opening and closing 1 surface and to which the opening and closing branch channel is connected, the opening and closing module further includes an opening and closing quick coupler coupled to the opening and closing branch port and configured to prevent the oil delivered to the opening and closing B channel from flowing back toward the opening and closing branch port, and the oil that is supplied to the driving module is supplied from the opening and closing A1 port or the opening and closing quick coupler.

Here, the driving module includes a driving body including a driving block in a hexahedral shape, at least one of a driving A1 port and a driving B1 port that are spaced apart from each other on a driving 1 surface of the driving block, a driving P1 port and a driving T1 port, at least one of a driving A2 port and a driving B2 port that are spaced apart from each other on a driving 2 surface of the driving block facing the driving 1 surface, a driving P2 port and a driving T2 port, at least one of a driving A channel (that connects the driving A1 port and the driving A2 port) and a driving B channel (that connects the driving B1 port and the driving B2 port), a driving P channel that connects the driving P1 port and the driving P2 port, and a driving T channel that connects the driving T1 port and the driving T2 port; and a driving control valve configured to deliver oil delivered to the driving P2 port to the driving A2 port or the driving B2 port, or to deliver oil delivered to the driving A2 port or the driving B2 port to the driving T2 port, and the oil that is delivered to the cylinder hydraulic chamber is delivered from the opening and closing module and supplied from the driving P1 port.

Here, the driving module further includes a driving check member provided to the driving P channel and configured to prevent the oil delivered to the driving P channel from flowing back toward the driving P1 port.

The integrity diagnosis module of the actuator with the oil cleaning function according to the present invention further includes an emergency module coupled at an emergency stop valve position of the actuator and configured to supply the oil or recover the oil based on a dump chamber side provided to the actuator.

Here, the emergency module includes an emergency body including an emergency block in a hexahedral shape, at least one of an emergency A port and an emergency B port that are spaced apart from each other on an emergency 1 surface of the emergency block, an emergency P port and an emergency T port, a cartridge groove formed in a recessed form on an emergency 2 surface of the emergency block that faces the emergency 1 surface in correspondence to the emergency P port, a first circulation port and a second circulation port that are spaced apart from each other on outer circumference of the emergency block, a first circulation channel that branches from an A port portion of the cartridge groove or a B port portion of the cartridge groove and is connected to the first circulation port, a second circulation channel that connects the second circulation port and the emergency A port or connects the second circulation port and the emergency B port, an emergency P channel that connects the emergency P port and a P port portion of the cartridge groove, and an emergency T channel that branches from a T port portion of the cartridge groove and is connected to the emergency T port; a circulation line configured to connect the first circulation path and the second circulation path for communication between the A port portion and the emergency A port or for communication between the B port portion and the emergency B port; and an emergency control valve inserted into and thereby coupled to the cartridge groove and configured to deliver the oil delivered to the emergency P channel to the first circulation channel or to deliver the oil delivered to the second circulation channel to the emergency T channel.

Here, the emergency body further includes an emergency branch P channel that branches from the emergency P channel and an emergency branch P port provided to outer circumference of the emergency body and to which the emergency branch P channel is connected, the emergency module further includes an emergency quick coupler coupled to the emergency branch P port and configured to prevent the oil delivered to the P port portion of the cartridge groove from flowing back toward the emergency branch P port, and the oil that is supplied to the dump hydraulic chamber is supplied from the emergency P port or the emergency quick coupler.

Here, the emergency module further includes an emergency check member provided to the emergency P channel and configured to prevent the oil delivered to the emergency P channel from flowing back toward the emergency P port.

### Effect

According to an integrity diagnosis module of an actuator with an oil cleaning function according to the present invention, it is possible to implement an oil cleaning function of an actuator through coupling at a valve position of the actuator and also implement an integrity diagnosis function of the actuator without a need to replace a module.

Also, according to the present invention, in the case of considering characteristics of a diagnosis module and characteristics of an actuator, a replacement work is omitted between a cleaning work of the actuator and an integrity diagnosis work of the actuator and thus, it is possible to improve efficiency of the replacement work and to reduce a working time and working cost according to the replacement work. Also, by reducing a number times that the replacement work is performed, it is possible to reduce abrasion of a coupling portion at a valve position of the actuator and further to prevent oil leakage at the coupling portion and to extend a lifespan of the actuator.

Also, according to the present invention, in the case of considering characteristics of a diagnosis module and characteristics of an actuator, a treatment work of leakage oil is omitted between a cleaning work of the actuator and an integrity diagnosis work of the actuator and thus, it is possible to improve efficiency of the treatment work and to reduce a treatment time and treatment cost according to the leakage oil treatment. Also, by reducing a number of times that the treatment work is performed, it is possible to reduce an amount of waste generated during the treatment of leakage oil and further to reduce environmental pollution cause by the waste.

Also, according to the present invention, it is possible to clarify an oil supply form and an oil recovery form through a coupling relationship between a driving body and a driving control valve in a detailed configuration of a driving module and to maintain characteristics of a driving valve as is. Also, it is possible to easily control an operation method of the driving control valve in a manual or automatic manner.

Also, according to the present invention, it is possible to supply oil by dividing oil supplied to an actuator into cleaning oil and test oil through a coupling relationship between a driving body and a driving quick coupler in a detailed configuration of a driving module and to perform an integrity diagnosis work of the actuator without replacing the driving module after finishing an oil cleaning work of the actuator.

Also, according to the present invention, in terms of operating a driving module through a coupling relationship between a driving body and a driving check member in a detailed configuration of the driving module, it is possible to precisely prevent cleaning oil from flowing back into a port to which test oil is supplied when supplying the cleaning oil and to precisely prevent the test oil from flowing back into a port to which the cleaning oil is supplied when supplying the test oil.

Also, according to the present invention, it is possible to clarify an oil supply form and an oil recovery form through a coupling relationship between an emergency body and an emergency control valve and a circulation line in a detailed configuration of an emergency module and to maintain characteristics of an emergency valve as is. Also, it is possible to easily control an operation method of the emergency control valve in a manual or automatic manner.

In particular, it is possible to minimize volume of the emergency module through the coupling relationship between the emergency body and the emergency control valve and to easily couple the emergency module at an emergency valve position without interference from surroundings.

Also, according to the present invention, it is possible to supply oil by dividing oil supplied to an actuator into cleaning oil and a test oil through a coupling relationship between an emergency body and an emergency quick coupler in a detailed configuration of an emergency module and to perform an integrity diagnosis work of the actuator without replacing the emergency module after finishing an oil cleaning work of the actuator.

Also, according to the present invention, in terms of operating an emergency module through a coupling relationship between an emergency body and an emergency check member in a detailed configuration of the emergency module, it is possible to precisely prevent cleaning oil from flowing back into a port to which test oil is supplied when supplying the cleaning oil and to precisely prevent the test oil from flowing back into a port to which the cleaning oil is supplied when supplying the test oil.

Also, according to the present invention, it is possible to control a movement speed or a movement amount of oil that moves in a circulation line through a coupling relationship between the circulation line and a control valve in a detailed configuration of an emergency module.

Also, according to the present invention, it is possible to supply oil by dividing oil supplied to an actuator into cleaning oil and test oil through a coupling relationship between an opening and closing body and an opening and closing quick coupler in a detailed configuration of an opening and closing module and to perform an integrity diagnosis work of the actuator without replacing the opening and closing module after finishing an oil cleaning work of the actuator.

Also, according to the present invention, it is possible to clarify an oil supply form through a coupling relationship between an opening and closing body and an opening and closing line in a first detailed configuration of an opening and closing module, to expand a channel in the opening and closing body, and to precisely control the opening and closing module.

In particular, in terms of operating the opening and closing module through a coupling relationship between the opening and closing line and an opening and closing valve, it is possible to precisely prevent cleaning oil from flowing back into a port to which test oil is supplied when supplying the cleaning oil and to precisely prevent the test oil from flowing back into a port to which the cleaning oil is supplied through the opening and closing line when supplying the test oil.

Also, according to the present invention, it is possible to clarify an oil supply form through a coupling relationship between an opening and closing body and a connection channel in a second detailed configuration of an opening and closing module, to make the opening and closing module compact, and to precisely control the opening and closing module.

In particular, in terms of operating the opening and closing module through a coupling relationship between a connection channel and an opening and closing check member, it is possible to precisely prevent cleaning oil from flowing back into a port to which test oil is supplied when supplying the cleaning oil and to precisely prevent the test oil from flowing back into a port to which the cleaning oil is supplied through an opening and closing line when supplying the test oil.

### BRIEF DESCRIPTION OF THE DRAWINGS

FIG. 1 illustrates an operating state of an actuator according to an embodiment of the present invention.

FIG. 2 is a perspective illustrating a first example of a driving module in an integrity diagnosis module of an actuator with an oil cleaning function according to an embodiment of the present invention.

FIG. 3 is a schematic view of the first example of the driving module in the integrity diagnosis module of the actuator with the oil cleaning function according to an embodiment of the present invention.

FIG. 4 is a perspective view illustrating a second example of a driving module in an integrity diagnosis module of an actuator with an oil cleaning function according to an embodiment of the present invention.

FIG. 5 is a schematic view of the second example of the driving module in the integrity diagnosis module of the actuator with the oil cleaning function according to an embodiment of the present invention.

FIG. 6 is a perspective view illustrating a third example of a driving module in an integrity diagnosis module of an actuator with an oil cleaning function according to an embodiment of the present invention.

FIG. 7 is a schematic view of the third example of the driving module in the integrity diagnosis module of the actuator with the oil cleaning function according to an embodiment of the present invention.

FIG. 8 is a perspective view illustrating a first example of an emergency module in an integrity diagnosis module of an actuator with an oil cleaning function according to an embodiment of the present invention.

FIG. 9 is a schematic view of the first example of the emergency module in the integrity diagnosis module of the actuator with the oil cleaning function according to an embodiment of the present invention.

FIG. 10 is a perspective view illustrating a second example of an emergency module in an integrity diagnosis module of an actuator with an oil cleaning function according to an embodiment of the present invention.

FIG. 11 is a schematic view of the second example of the emergency module in the integrity diagnosis module of the actuator with the oil cleaning function according to an embodiment of the present invention.

FIG. 12 is a perspective view illustrating a first example of an opening and closing module in an integrity diagnosis module of an actuator with an oil cleaning function according to an embodiment of the present invention.

FIG. 13 is a schematic view of the first example of the opening and closing module in the integrity diagnosis module of the actuator with the oil cleaning function according to an embodiment of the present invention.

FIG. 14 is a schematic view of a second example of an opening and closing module in an integrity diagnosis module of an actuator with an oil cleaning function according to an embodiment of the present invention.

### DETAILED DESCRIPTION OF THE EMBODIMENTS

Hereinafter, an embodiment of an integrity diagnosis module of an actuator with an oil cleaning function according to the present invention is described with reference to the accompanying drawings. Here, the present invention is not limited to or restricted by the embodiment. Also, in describing the present invention, detailed description related to a known function or configuration may be omitted to clarify subject matter of the present invention.

In the following description related to oil, hydraulic oil refers to oil supplied for driving of an actuator 100, cleaning oil refers to oil supplied for a cleaning function of the actuator 100, and test oil refers to oil supplied for integrity diagnosis of the actuator 100.

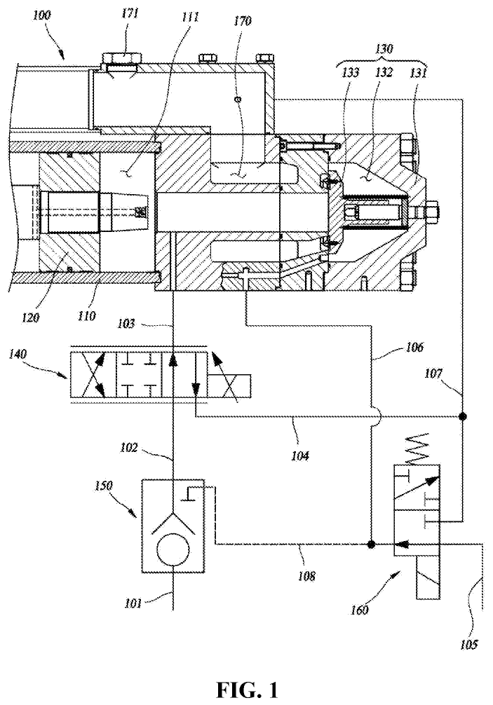

Referring to FIG. 1, the actuator 100 of a power plant according to an embodiment of the present invention may include a cylinder 110, a piston 120, and a dump portion 130, may further include a drain chamber 170, and may further include a driving valve 140, an opening and closing valve 150, and an emergency stop valve 160.

The hydraulic oil is supplied to the cylinder 110. A cylinder hydraulic chamber 111 configured to contain the hydraulic oil is formed in the cylinder 110. Also, a hydraulic operation channel configured to communicate with the cylinder hydraulic chamber 111 may be formed in the cylinder 110.

The piston 120 partitions the cylinder hydraulic chamber 111 and slides in the cylinder 110 by the hydraulic oil contained in the cylinder hydraulic chamber 111.

The dump portion 130 controls an operation of the actuator 100. The dump portion 130 may control sliding of the piston 120 in the actuator 100 in such a manner that the cylinder hydraulic chamber 111 is opened or closed according to the hydraulic oil being supplied.

The dump portion 130 may include a dump cap 131 and a dump sheet 133.

The dump cap 131 couples with the cylinder 110 to form a dump hydraulic chamber 132 configured to contain the hydraulic oil. The dump hydraulic chamber 132 communicates with the cylinder hydraulic chamber 111.

The dump sheet 133 controls an opening and closing operation of the cylinder hydraulic chamber 111 and the dump hydraulic chamber 132 and the drain chamber 170 by controlling the hydraulic oil that is supplied to the dump hydraulic chamber 132. In case of an emergency, the dump sheet 133 allows the drain chamber 170 to communicate with the cylinder hydraulic chamber 111 and the dump hydraulic chamber 132, such that the hydraulic oil may be quickly discharged.

A dump hydraulic channel for communicating with the dump hydraulic chamber 132 and thereby supplying the hydraulic oil to the dump hydraulic chamber 132 may be formed in the dump portion 130.

The drain chamber 170 is a space in which the hydraulic oil is contained. The hydraulic oil of the drain chamber 170 may operate the piston 120 and may be delivered to a tank (not shown). A drain portion 171 for connection to the tank (not shown) may be provided to the drain chamber 170.

The driving valve 140, the opening and closing valve 150, and the emergency stop valve 160 are connected to the actuator 100.

The driving valve 140 selects whether to supply the hydraulic oil that is supplied to the cylinder hydraulic chamber 111 of the cylinder 110. The driving valve 140 controls the hydraulic oil being supplied to the cylinder hydraulic chamber 111 for an operation of the actuator 100. The driving valve 140 may be configured as a servo valve or a solenoid valve according to an operation method of the actuator 100. A delivery line 102 is connected to a driving input port of the driving valve 140, an operation line 103 is connected to a first driving port of the driving valve 140, and a return line 104 is connected to a second driving port of the driving valve 140.

The opening and closing valve 150 determines whether to supply the hydraulic oil to a side of the actuator 100. The opening and closing valve 150 selects whether to supply the hydraulic oil being supplied to the driving valve 140 according to an opening and closing operation of the emergency stop valve 160. The opening and closing valve 150 may be configured as a shut-off valve. A hydraulic signal line 101 is connected to an opening and closing input port of the opening and closing valve 150 and the delivery line 102 is connected to a discharge port of the opening and closing valve 150.

The emergency stop valve 160 controls the hydraulic oil to control an operation of the actuator 100. The emergency stop valve 160 selects whether to supply the hydraulic oil being supplied to the dump hydraulic chamber 132 of the dump portion 130. The emergency stop valve 160 may be configured as a servo valve or a solenoid valve according to an operation method of the actuator 100. An emergency stop line 105 is connected to an emergency input port of the emergency stop valve 160, a dump oil supply line 106 is connected to an oil supply port of the emergency stop valve 160, and a dump drain line 107 is connected to a drain port of the emergency stop valve 160.

Here, the hydraulic signal line 101 supplies the hydraulic oil by connecting to the opening and closing valve 150. The hydraulic oil of the hydraulic signal line 101 may be supplied to the actuator 100 and slide the piston 120 in the cylinder 110 accordingly.

The delivery line 102 forms a path through which the hydraulic oil is delivered from the opening and closing valve 150 to the driving valve 140 by connecting the driving valve 140 and the opening and closing valve 150.

The operation line 103 delivers the hydraulic oil delivered to the driving valve 140 to the cylinder hydraulic chamber 111 formed on one side of the piston 120. The operation line 103 forms a path through which the hydraulic oil is supplied to one side of the piston 120 by connecting the driving valve 140 and the actuator 100.

The return line 104 delivers the hydraulic oil delivered to the driving valve 140 to the drain chamber 170 by connecting the driving valve 140 and the dump drain line 107 or by connecting the driving valve 140 and the drain chamber 170.

The emergency stop line 105 supplies the hydraulic oil to the emergency stop valve 160 by connecting to the emergency stop valve 160. The hydraulic oil of the emergency stop line 105 is used as dump oil for controlling an operation of the actuator 100.

The dump oil supply line 106 supplies the hydraulic oil of the emergency stop valve 160 to the dump hydraulic chamber 132 by connecting the emergency stop valve 160 and the dump hydraulic chamber 132.

The dump drain line 107 supplies the hydraulic oil of the emergency stop valve 160 to the drain chamber 170 by connecting the emergency stop valve 160 and the drain chamber 170.

An opening and closing operation line 108 delivers the hydraulic oil of the emergency stop valve 160 to the opening and closing valve 150 by connecting the opening and closing valve 150 and the emergency stop valve 160 to control an operation of the actuator.

If the driving valve 140 is excited, the driving valve 140 may deliver the hydraulic oil from the driving valve 140 to the cylinder hydraulic chamber 111 formed on one side of the piston 120 by allowing the delivery line 102 to communicate with the operation line 103. If excitement of the driving valve 140 is released, the driving valve 140 may deliver the hydraulic oil from the driving valve 140 to the drain chamber 170 by allowing the operation line 103 to communicate with the return line 104.

Also, if the emergency stop valve 160 is excited, the emergency stop valve 160 may deliver the hydraulic oil from the emergency stop valve 160 to the opening and closing valve 150 by allowing the emergency stop line 105 to communicate with the opening and closing operation line 108 and may deliver the hydraulic oil from the emergency stop valve 160 to the dump hydraulic chamber 132 of the dump portion 130 by allowing the emergency stop line 105 to communicate with the dump oil supply line 106. If excitement of the emergency stop valve 160 is released in response to emergency stop of the actuator, the emergency stop valve 160 may deliver the hydraulic oil from the dump hydraulic chamber 132 to the drain chamber 170 by allowing the dump oil supply line 106 to communicate with the dump drain line 107.

Also, if the hydraulic oil opens the opening and closing valve 150 due to excitement of the emergency stop valve 160, the opening and closing valve 150 may deliver the hydraulic oil from the opening and closing valve 150 to the driving valve 140 by allowing the hydraulic signal line 101 to communicate with the delivery line 102. If the excitement of the emergency stop valve 160 is released, the hydraulic oil closes the opening and closing valve 150 and the hydraulic oil of the hydraulic signal line 101 is not supplied to the delivery line 102 accordingly.

Although not illustrated, a position sensor may be provided to the cylinder 110 and be used to sense a position of the piston 120 by sensing a movement of the piston 120 or to control an operation of the actuator 100.

In an integrity diagnosis module of an actuator with an oil cleaning function according to an embodiment of the following invention, each channel may be easily formed in a corresponding body by allowing each channel to be substantially perpendicular relative to a surface on which a corresponding port is formed. Also, a cartridge groove 313 is formed in a recessed form substantially perpendicular to an emergency 2 surface 311-2.

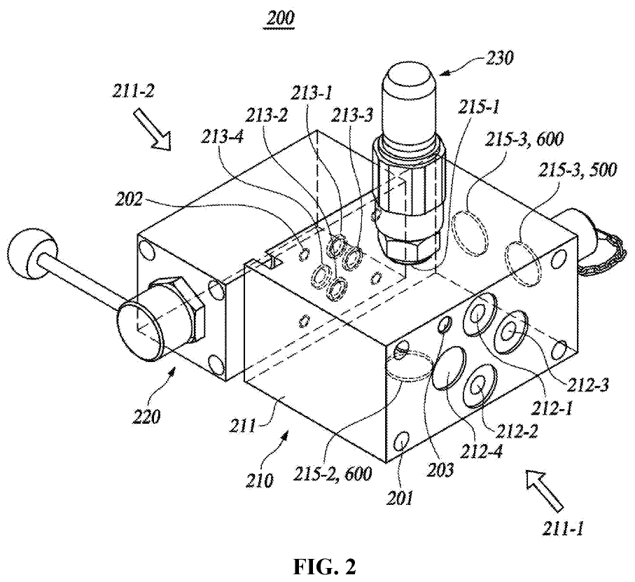

In performing an oil cleaning function and an integrity diagnosis function according to a first method, referring to FIGS. 2 to 11, an integrity diagnosis module of an actuator with an oil cleaning function according to an embodiment of the present invention may include one of a driving module 200 and an emergency module 300.

The driving module 200 is coupled at a position of the driving valve 140 of the actuator 100. The driving module 200 supplies oil for an oil cleaning function of the actuator 100 or an integrity diagnosis function of the actuator 100 to the cylinder hydraulic chamber 111 provided to the actuator 100 or recovers the oil from the cylinder hydraulic chamber 111 provided to the actuator 100. The driving module 200 may include a driving body 210 and a driving control valve 220, and may further include a driving quick coupler 230.

The driving body 210 includes a driving block 211 in a hexahedral shape, at least one of a driving A1 port 212-3 and a driving B1 port 212-4 that are spaced apart from each other on a driving 1 surface 211-1 of the driving block 211, a driving P1 port 212-1 and a driving T1 port 212-2, at least one of a driving A2 port 213-3 and a driving B2 port 213-4 that are spaced apart from each other on a driving 2 surface 211-2 of the driving block 211 facing the driving 1 surface 211-1, a driving P2 port 213-1 and a driving T2 port 213-2, at least one of a driving A channel 214-3 (that connects the driving A1 port 212-3 and the driving A2 port 213-3) and a driving B channel 214-4 (that connects the driving B1 port 212-4 and the driving B2 port 213-4), a driving P channel 214-1 that connects the driving P1 port 212-1 and the driving P2 port 213-1, and a driving T channel 214-2 that connects the driving T1 port 212-2 and the driving T2 port 213-2.

Here, a driving coupling groove into which a sealing ring inserts is formed in the driving P1 port 212-1 and the driving T1 port 212-2, and the driving A1 port 212-3 and the driving B1 port 212-4, thereby improving adhesion of the driving body 210 at the position of the driving valve 140 and preventing oil leakage in a coupling portion.

The driving body 210 further includes a driving branch P channel 216-1 that branches from the driving P channel 214-1 and a driving branch P port 215-1 provided to the outer circumference of the driving body 210 and to which the driving branch P channel 216-1 is connected.

The driving 1 surface 211-1 is a surface that faces the position of the driving valve 140 of the actuator 100, the driving 2 surface 211-2 is a surface that faces the driving 1 surface 211-1, and a driving side surface is a surface that connects the driving 1 surface 211-1 and the driving 2 surface 211-2.

Here, a virtual line that sequentially connects the driving T1 port 212-2, the driving A1 port 212-3, the driving P1 port 212-1, the driving B1 port 212-4, and the driving T1 port 212-2 based on the driving 1 surface 211-1 represents a rhombus shape, a V shape, or a [symbol] shape.

The driving control valve 220 is couple to the driving 2 surface 211-2. The driving control valve 220 delivers the oil delivered to the driving P2 port 213-1 to the driving A2 port 213-3 or the driving B2 port 213-4, or delivers the oil delivered to the driving A2 port 213-3 or the driving B2 port 213-4 to the driving T2 port 213-2. The driving control valve 220 may be manually controllable as a hand valve type or may be automatically controllable as a solenoid type.

Although an embodiment of the present invention illustrates a virtual line that sequentially connects the driving T2 port 213-2, the driving A2 port 213-3, the driving P2 port 213-1, the driving B2 port 213-4, and the driving T2 port 213-2 based on the driving 2 surface 211-2 to which the driving control valve 220 is coupled as a rhombus shape, the virtual line may represent a V shape or a [symbol] shape, which is described above. Since the driving control valve 220 uses a smaller standard than that of the driving valve 140, the driving module 200 may be compactly designed based on a size of the driving valve 140.

The driving quick coupler 230 is coupled to the driving branch P port 215-1. The driving quick coupler 230 has a checking function of preventing the oil delivered to the driving P channel 214-1 from flowing back toward the driving branch P port 215-1. A separate driving line may be coupled to the driving quick coupler 230, thereby supplying test oil to the driving body 210.

Next, the oil that is supplied to the cylinder hydraulic chamber 111 may be supplied from the driving P1 port 212-1 or the driving quick coupler 230.

The driving module 200 may further include a driving check member 240.

The driving check member 240 is provided to the driving P channel 214-1. The driving check member 240 may be coupled to a side of the driving P1 port 212-1 between a branch point of the driving branch P channel 216-1 and the driving P1 port 212-1, thereby preventing the oil delivered to the driving P channel 214-1 from flowing back again toward the driving P1 port 212-1 and simplifying repair and maintenance of the driving check member 240 on the side of the driving P1 port 212-1.

A not-described reference numeral 201 refers to a driving coupling portion that is formed in a penetrating form in the driving body 210 to couple the driving body 210 at the position of the driving valve 140 of the actuator 100, and a not-described reference numeral 202 refers to a valve coupling portion that is formed in a recessed form in the driving body 210 to couple the driving control valve 220 to the driving body 210. Also, a not-described reference numeral 203 refers to a driving pilot port that is formed on the driving 1 surface 211-1 to correspond to a pilot port of the driving valve 140. A driving pilot coupling groove into which a sealing ring inserts may be formed in the driving pilot port 203, thereby improving adhesion of the driving body 210 at the position of the driving valve 140 and preventing oil leakage in a coupling portion.

If the oil is supplied to the driving P1 port 212-1 or the driving quick coupler 230 to which the delivery line 102 is connected, the driving control valve 220 connects the driving P channel 214-1 and the driving A channel 214-3 or connects the driving P channel 214-1 and the driving B channel 214-4. Therefore, the oil is discharged to the operation line 103 through the driving A1 port 212-3 or the driving B1 port 212-4. Also, if the oil is supplied to the driving A1 port 212-3 or the driving B1 port 212-4, the driving control valve 220 connects the driving A channel 214-3 and the driving T channel 214-2 or connects the driving B channel 214-4 and the driving T channel 214-2. Therefore, the oil is discharged to the return line 104 through the driving T1 port 212-2.

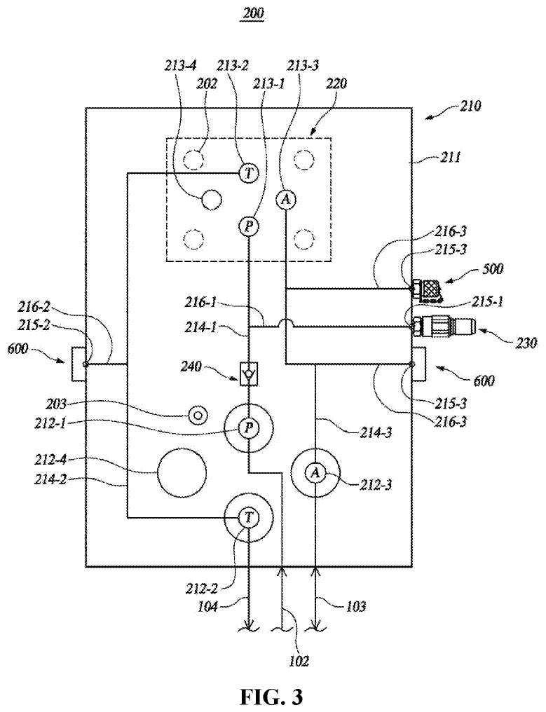

Referring to FIGS. 2 and 3, in a first example of the driving module 200, a virtual line that sequentially connects the driving T1 port 212-2, the driving A1 port 212-3, the driving P1 port 212-1, the driving B1 port 212-4, and the driving T1 port 212-2 based on the driving 1 surface 211-1 represents a rhombus shape and a virtual line that sequentially connects the driving T2 port 213-2, the driving A2 port 213-3, the driving P2 port 213-1, the driving B2 port 213-4, and the driving T2 port 213-2 based on the driving 2 surface 211-2 represents a rhombus shape. Here, in the driving body 210, the driving P channel 214-1, the driving A channel 214-3, and the driving T channel 214-2 are formed and the driving B channel 214-4 is not formed.

Since there is a difference between a standard of the driving valve 140 and a standard of the driving control valve 220, a virtual center line that is substantially perpendicular to the driving P1 port 212-1 and a virtual center line that is substantially perpendicular to the driving P2 port 213-1 are in a parallel state. Therefore, the driving branch P channel 216-1 connects the driving P channel 214-1 that extends from the driving P1 port 212-1 and the driving P channel 214-1 that extends from the driving P2 port 213-1. The driving quick coupler 230 may be coupled to the driving branch P port 215-1, and the driving check member 240 may be coupled to the driving P channel 214-1 that extends from the driving P1 port 212-1.

In the first example of the driving module 200, the driving body 210 may further include a driving branch T channel 216-2 that connects a driving T channel 214-2 extending from a driving T1 port 212-2 and the driving T channel 214-2 extending from a driving T2 port 213-2 according to a difference between the standard of the driving valve 140 and the standard of the driving control valve 220 and a driving branch T port 215-2 provided to the outer circumference of the driving body 210 to which the driving branch T channel 216-2 is connected. A check point 500 for observing oil flow of the driving T channel 214-2 or a closing cap 600 for closing the driving branch T port 215-2 to prevent oil leakage may be coupled to the driving branch T port 215-2. If the check point 500 is coupled, a temperature sensor or a pressure sensor may be coupled to the check point 500 to correspond to delivery of oil.

In the first example of the driving module 200, the driving body 210 may further include a driving branch A channel 216-3 and a driving branch A port 215-3. Due to a difference between the standard of the driving valve 140 and the standard of the driving control valve 220, the driving branch A channel 216-3 includes a driving branch A1 channel that connects the driving A channel 214-3 extending from the driving A1 port 212-3 and the driving A channel 214-3 extending from the driving A2 port 213-3 and a driving branch A2 channel that branches from the driving A channel 214-3 between the driving A2 port 213-3 and the driving branch A1 channel. Therefore, the driving branch A port 215-3 provided to the outer circumference of the driving body 210 includes a driving branch A1 port to which the driving branch A1 channel is connected and a driving branch A2 port to which the driving branch A2 channel is connected. The check point 500 for observing oil flow of the driving A channel 214-3 or the closing cap 600 for closing the driving branch A port 215-3 to prevent oil leakage may be coupled to the driving branch A port 215-3. If the check point 500 is coupled, a temperature sensor or a pressure sensor may be coupled to the check point 500 to correspond to delivery of oil.

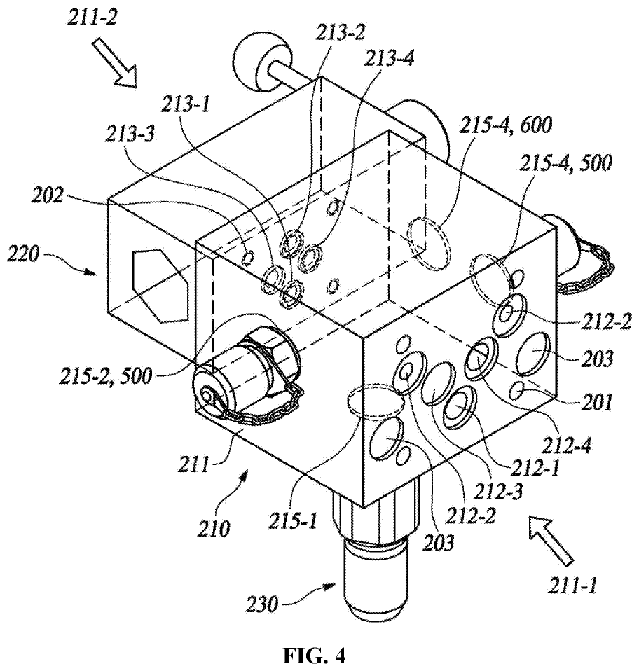

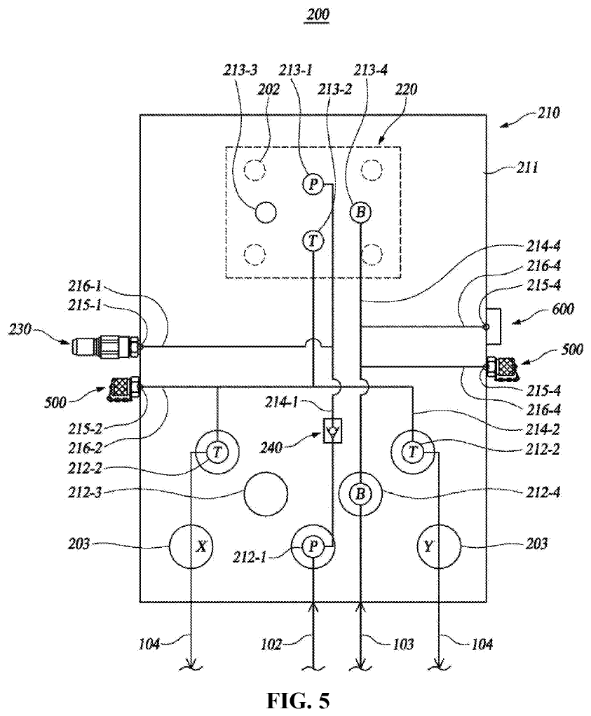

Referring to FIGS. 4 and 5, in a second example of the driving module 200, a virtual line that sequentially connects the driving T1 port 212-2, the driving A1 port 212-3, the driving P1 port 212-1, the driving B1 port 212-4, and the driving T1 port 212-2 based on the driving 1 surface 211-1 represents a V shape and a virtual line that sequentially connects the driving T2 port 213-2, the driving A2 port 213-3, the driving P2 port 213-1, the driving B2 port 213-4, and the driving T2 port 213-2 based on the driving 2 surface 211-2 represents a rhombus shape. Here, in the driving body 210, the driving P channel 214-1, the driving B channel 214-4, and the driving T channel 214-2 are formed and the driving A channel 214-3 is not formed.

Since there is a difference between the standard of the driving valve 140 and the standard of the driving control valve 220, a virtual center line that is substantially perpendicular to the driving P1 port 212-1 and a virtual center line that is substantially perpendicular to the driving P2 port 213-1 are in a parallel state. Therefore, the driving branch P channel 216-1 connects the driving P channel 214-1 that extends from the driving P1 port 212-1 and the driving P channel 214-1 that extends from the driving P2 port 213-1. The driving quick coupler 230 may be coupled to the driving branch P port 215-1, and the driving check member 240 may be coupled to the driving P channel 214-1 that extends from the driving P1 port 212-1.

In the second example of the driving module 200, the driving body 210 may further include the driving branch T channel 216-2 that branches from a single pair of driving T channels 214-2 and the driving branch T port 215-2 provided to the outer circumference of the driving body 210 and to which the driving branch T channel 216-2 is connected. Here, due to a difference between the standard of the driving valve 140 and the standard of the driving control valve 220, the driving branch T channel 216-2 connects a single pair of driving T channels 214-2 that extend from a single pair of driving T1 ports 212-2 and the driving T channel 214-2 that extends from the driving T2 port 213-2. The check point 500 for observing oil flow of the driving T channel 214-2 or the closing cap 600 for closing the driving branch T port 215-2 to prevent oil leakage may be coupled to the driving branch T port 215-2. If the check point 500 is coupled, a temperature sensor or a pressure sensor may be coupled to the check point 500 to correspond to delivery of oil.

In the second example of the driving module 200, the driving body 210 may further include a driving branch B channel 216-4 and a driving branch B port 215-4. Due to a difference between the standard of the driving valve 140 and a standard of the driving control valve, the driving branch B channel 216-4 includes a driving branch B1 channel that connects the driving B channel 214-4 extending from the driving B1 port 212-4 and the driving B channel 214-4 extending from the driving B2 port 213-4 and a driving branch B2 channel that branches from the driving B channel 214-4 between the driving B2 port 213-4 and the driving branch B1 channel. In correspondence thereto, the driving branch B port 215-4 includes a driving branch B1 port provided to the outer circumference of the driving body 210 and to which the driving branch B1 channel is connected and a driving branch B2 port provided to the outer circumference of the driving body 210 and to which the driving branch B2 channel is connected. The check point 500 for observing oil flow of the driving T channel 214-4 or the closing cap 600 for closing the driving branch T port 215-4 to prevent oil leakage may be coupled to the driving branch T port 215-4. If the check point 500 is coupled, a temperature sensor or a pressure sensor may be coupled to the check point 500 to correspond to delivery of oil.

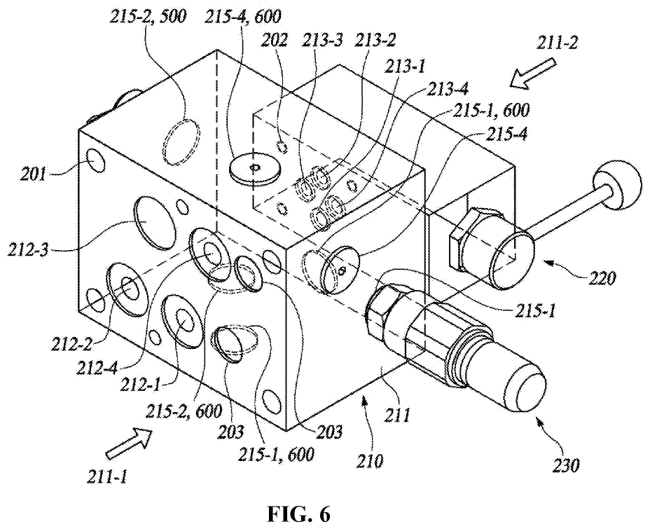

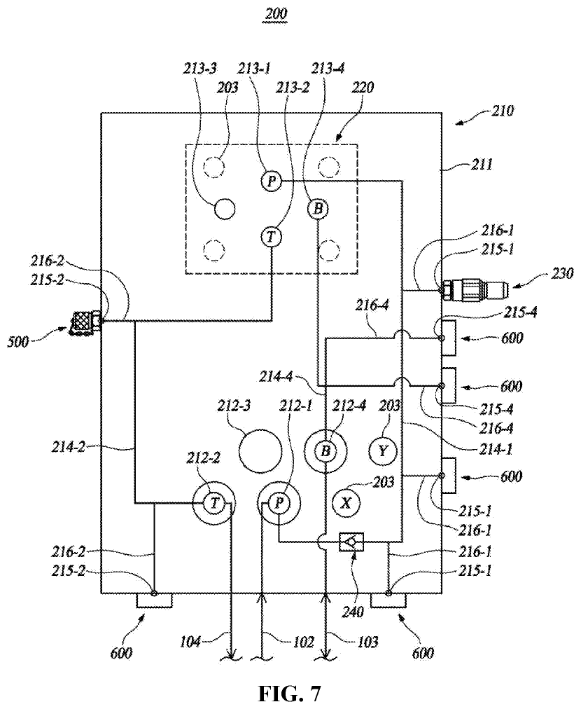

Referring to FIGS. 6 and 7, in a third example of the driving module 200, a virtual line that sequentially connects the driving T1 port 212-2, the driving A1 port 212-3, the driving P1 port 212-1, the driving B1 port 212-4, and the driving T1 port 212-2 based on the driving 1 surface 211-1 represents a [symbol] shape, and a virtual line that sequentially connects the driving T2 port 213-2, the driving A2 port 213-3, the driving P2 port 213-1, the driving B2 port 213-4, and the driving T2 port 213-2 based on the driving 2 surface 211-2 represents a rhombus shape. Here, in the driving body 210, the driving P channel 214-1, the driving B channel 214-4, and the driving T channel 214-2 are formed and the driving A channel 214-3 is not formed.

Since there is a difference between the standard of the driving valve 140 and the standard of the driving control valve 220, a virtual center line that is substantially perpendicular to the driving P1 port 212-1 and a virtual center line that is substantially perpendicular to the driving P2 port 213-1 are in a parallel state. Therefore, the driving branch P channel 216-1 may include a driving branch P1 channel that connects the driving P channel 214-1 extending from the driving P1 port 212-1 and the driving P channel 214-1 branching from the driving P2 port 213-1, a driving branch P2 channel that branches from the driving branch P1 channel, and a driving P3 channel that branches from the driving P channel 214-1 extending from the driving P2 port 213-1. Therefore, the driving branch P port 215-1 may include a driving branch P1 port to which the driving branch P1 channel is connected, a driving branch P2 port to which the driving branch P2 channel is connected, and a driving branch P3 port to which the driving branch P3 channel is connected. Here, the driving quick coupler 230 may be coupled to the driving branch P3 port and the driving check member 240 may be coupled to the driving P channel 214-1 that extends from the driving P1 port 212-1. The check point 500 for observing oil flow of the driving P channel 214-1 or the closing cap 600 for closing the corresponding driving branch P port 215-1 to prevent oil leakage may be coupled to the driving branch P1 port and the driving branch P2 port. If the check point 500 is coupled, a temperature sensor or a pressure sensor may be coupled to the check point 500 to correspond to delivery of oil. The driving check member 240 may be coupled to the driving P channel 214-1 that extends from the driving P1 port 212-1.

In the third example of the driving module 200, the driving body 210 may further include the driving branch T channel 216-2 and the driving branch T port 215-2 provided to the outer circumference of the driving body 210. Due to a difference between the standard of the driving valve 140 and the standard of the driving control valve 220, the driving branch T channel 216-2 may include a driving branch T1 channel that is connected to the driving B channel 214-4 extending from the driving T1 port 212-2 and a driving branch T2 channel that connects the driving B channel 214-4 extending from the driving B2 port 213-4 and the driving branch T1 channel. Therefore, the driving branch T port 215-2 may include a driving branch T1 port to which the driving branch T1 channel is connected and a driving branch T2 port to which the driving branch T2 channel is connected. The check point 500 for observing oil flow of the driving T channel 214-2 or the closing cap 600 for closing the driving branch T port 215-2 to prevent oil leakage may be coupled to the driving branch T port 215-2. If the check point 500 is coupled, a temperature sensor or a pressure sensor may be coupled to the check point 500 to correspond to delivery of oil.

In the third example of the driving module 200, the driving body 210 may further include the driving branch B channel 216-4 and the driving branch B port 215-4 provided to the outer circumference of the driving body 210. Due to a difference between the standard of the driving valve and the standard of the driving control valve, the driving branch B channel 216-4 includes the driving branch B1 channel that connects the driving B channel 214-4 extending from the driving B1 port 212-4 and the driving B channel 214-4 extending from the driving B2 port 213-4, and the driving branch B2 channel that branches from the driving branch B1 channel. Therefore, the driving branch B port 215-4 includes the driving branch B1 port to which the driving branch B1 channel is connected and the driving branch B2 port to which the driving branch B2 channel is connected. The check point 500 for observing oil flow of the driving B channel 214-4 or the closing cap 600 for closing the driving branch B port 215-4 to prevent oil leakage may be coupled to the driving branch B port 215-4. If the check point 500 is coupled, a temperature sensor or a pressure sensor may be coupled to the check point 500 to correspond to delivery of oil.

The emergency module 300 is coupled at a position of the emergency stop valve 160 of the actuator 100. The emergency module 300 supplies the oil for the cleaning function of the actuator 100 or the integrity diagnosis function of the actuator 100 to the dump hydraulic chamber 132 provided to the actuator 100, or recovers the oil from the dump hydraulic chamber 132 provided to the actuator 100. The emergency module 300 may include an emergency body 310, a circulation line 320, and an emergency control valve 330, and may further include an emergency quick coupler 340.

The emergency body 310 includes an emergency block 311 in a hexahedral shape, at least one of an emergency A port 312-3 and an emergency B port 312-4 that are spaced apart from each other on an emergency 1 surface 311-1 of the emergency block 311, an emergency P port 312-1 and an emergency T port 312-2, a cartridge groove 313 formed in a recessed form on an emergency 2 surface 311-2 of the emergency block 311 that faces the emergency 1 surface 311-1 in correspondence to the emergency P port 312-1, a first circulation port 314-1 and a second circulation port 315-1 that are spaced apart from each other on the outer circumference of the emergency block 311, a first circulation channel 314-2 that branches from an A port portion of the cartridge groove 313 or a B port portion of the cartridge groove 313 and is connected to the first circulation port 314-1, a second circulation channel 315-2 that connects the second circulation port 315-1 and the emergency A port 312-3 or connects the second circulation port 315-1 and the emergency B port 312-4, an emergency P channel 316-1 that connects the emergency P port 312-1 and a P port portion of the cartridge groove 313, and an emergency T channel 316-2 that extends from the emergency T port 312-2 to be connected to the T port portion of the cartridge groove 313.

Here, an emergency coupling groove into which a sealing ring inserts may be formed in the emergency P port 312-1, the emergency T port 312-2, the emergency A port 312-3, and the emergency B port 312-4, thereby improving adhesion of the emergency body 310 at a position of the emergency stop valve 160 and preventing oil leakage in a coupling portion.

Also, since the cartridge groove 313, the emergency P port 312-1, and the emergency P channel 316-1 are coaxially arranged, the cartridge groove 313 and the emergency control valve 330 may make the emergency module 300 compact at the position of the emergency stop valve 160 of the actuator 100 and may prevent the emergency module 300 from interfering with a surrounding component present at the position of the emergency stop valve 160.

The emergency body 310 further includes an emergency branch P channel 318-1 that branches from the emergency P channel 316-1 and an emergency branch P port 317-1 provided to the outer circumference of the emergency body 310 and to which the emergency branch P channel 318-1 is connected.

The emergency 1 surface 311-1 refers to a surface that faces the position of the emergency stop valve 160 of the actuator 100, the emergency 2 surface 311-2 refers to a surface that faces the emergency 1 surface 311-1, and an emergency side surface refers to a surface that connects the emergency 1 surface 311-1 and the emergency 2 surface 311-2.

Here, a virtual line that sequentially connects the emergency T port 312-2, the emergency A port 312-3, the emergency P port 312-1, the emergency B port 312-4, and the emergency T port 312-2 based on the emergency 1 surface 311-1 represents a rhombus shape or a V shape.

The circulation line 320 connects the first circulation channel 314-2 and the second circulation channel 315-2 for communication between the A port portion of the cartridge groove 313 and the emergency A port 312-3 or for communication between the B port portion of the cartridge groove 313 and the emergency B port 312-4. The circulation line 320 is provided at an outer side of the emergency body 310 and both ends of the circulation line 320 are connected to the first circulation port 314-1 and the second circulation port 315-1, respectively.

The emergency control valve 330 inserts into and couples to the cartridge groove 313. The emergency control valve 330 delivers the oil delivered to the emergency P channel 316-1 to the first circulation channel 314-2, or delivers the oil delivered to the second circulation channel 315-2 to the emergency T channel 316-2. The emergency control valve 330 may be manually controllable as a hand valve type or may be automatically controllable as a solenoid type.

In an embodiment of the present invention, since the emergency control valve 330 is a cartridge type valve that inserts into and couples to the cartridge groove 313, it is possible to make the emergency module 300 compact and to conveniently mount the emergency module 300 at the position of the emergency stop valve 160 without surrounding interference.

The emergency quick coupler 340 couples to the emergency branch P port 317-1. The emergency quick coupler 340 has a checking function of preventing the oil delivered to the P port portion of the cartridge groove 313 from flowing back toward the emergency branch P port 317-1. Since a separate emergency line couples to the emergency quick coupler 340, test oil may be supplied to the driving body 210.

The oil that is supplied to the dump hydraulic chamber 132 may be supplied from the emergency P port 312-1 or the emergency quick coupler 340.

The emergency module 300 may further include an emergency check member 350.

The emergency check member 350 is provided to the emergency P channel 316-1. The emergency check member 350 may be coupled to a side of the emergency P port 312-1 between the emergency P port 312-1 and the emergency branch P channel 318-1 in the emergency P channel 316-1, thereby preventing the oil delivered to the emergency P channel 316-1 from flowing back toward the emergency P port 312-1 and simplifying repair and maintenance of the emergency check member 350 on the side of the emergency P port 312-1.

The emergency module 300 may further include a control valve 360.

The control valve 360 is provided on the circulation line 320. The control valve 360 may select whether to deliver the oil that is delivered from the circulation line 320, or may control a delivery amount of oil. The control valve 360 may be manually controllable as a hand valve type or a dial valve type or may be automatically controllable as a solenoid type.

A not-described reference numeral 301 refers to an emergency coupling portion that is formed in a penetrating form in the emergency body 310 to couple the emergency body 310 at the position of the emergency stop valve 160 of the actuator 100. Although not illustrated, an emergency pilot port (not shown) may be formed in the emergency 1 surface 211-1 to correspond to a pilot port of the emergency stop valve 160. An emergency pilot coupling groove into which a sealing ring inserts may be formed in the emergency pilot port (not shown), thereby improving adhesion of the emergency body 210 at the position of the emergency stop valve 160 and preventing oil leakage in a coupling portion.

If the oil is supplied to the emergency P port 312-1 or the emergency quick coupler 340 to which the emergency stop line 105 is connected, the emergency control valve 330 connects the driving P channel 214-1 and the first circulation channel 314-2. Therefore, the oil is discharged to the dump oil supply line 106 through the circulation line 320, the second circulation channel 315-2, and the emergency A port 312-3. Also, if the oil is supplied to the emergency A port 312-3, the emergency control valve 330 connects the first circulation channel 314-2 and the emergency T channel 316-2. Therefore, the oil is discharged to the dump drain line 107 through the second circulation channel 315-2, the circulation line 320, the first circulation channel 314-2, the emergency T channel 316-2, and the emergency T port 312-2.

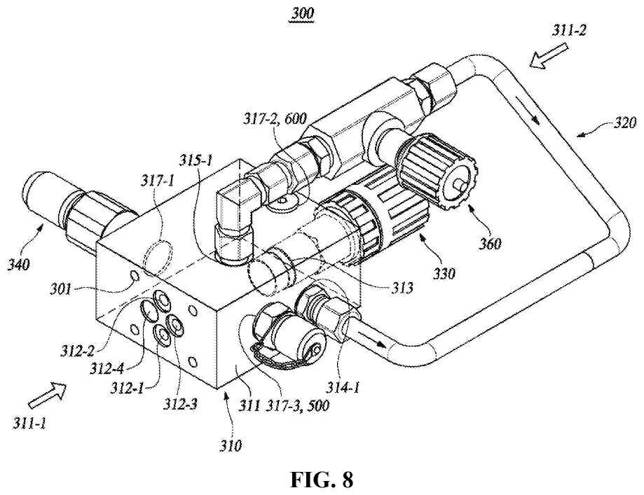

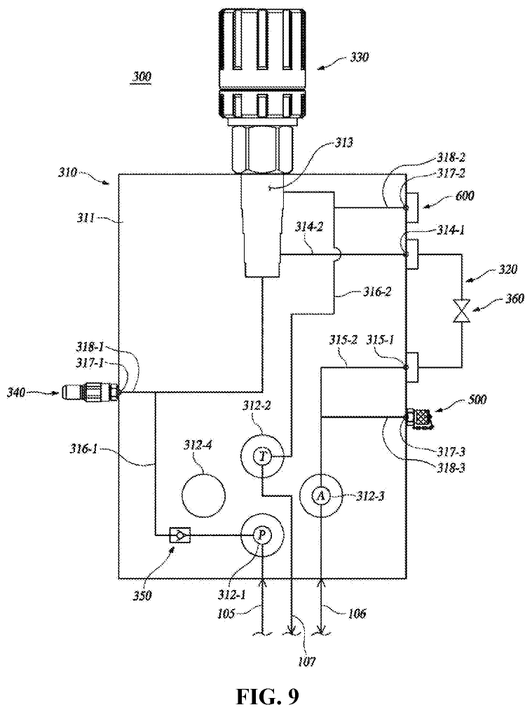

Referring to FIGS. 8 and 9, in a first example of the emergency module 300, a virtual line that sequentially connects the emergency T port 312-2, the emergency A port 312-3, the emergency P port 312-1, the emergency B port 312-4, and the emergency T port 312-2 based on the emergency 1 surface 311-1 represents a rhombus shape. Here, in the emergency body 310, the emergency P channel 316-1 and the emergency T channel 316-2 are formed, the first circulation channel 314-2, the second circulation channel 315-2, and the circulation line 320 are formed to correspond to the A port portion of the cartridge groove 313, and a channel is not connected to the B port portion of the cartridge groove 313.

The emergency P port 312-1, the emergency P channel 316-1, and the P port portion of the cartridge groove 313 may be coaxially provided on a straight line, the emergency branch P channel 318-1 may directly branch from the emergency P channel 316-1, the emergency quick coupler 340 may be coupled to the emergency branch P port 317-1, and the emergency check member 350 may be coupled between the emergency P port 312-1 and a branchpoint of the emergency branch P channel 318-1.

In the first example of the emergency module 300, the emergency body 310 may further include an emergency branch T channel 318-2 that branches from the emergency T channel 316-2 and an emergency branch T port 317-2 provided to the outer circumference of the emergency body 310 and to which the emergency branch T channel 318-2 is connected. The check point 500 for observing oil flow of the emergency T channel 316-2 or the closing cap 600 for closing the emergency branch T port 317-2 to prevent oil leakage may be coupled to the emergency branch T port 317-2. If the check point 500 is coupled, a temperature sensor or a pressure sensor may be coupled to the check point 500.

In the first example of the emergency module 300, the emergency body 310 may further include an emergency branch A channel 318-3 that branches from the second circulation channel 315-2 and an emergency branch A port 317-3 provided to the outer circumference of the emergency body 310 and to which the emergency branch A channel 318-3 is connected. The check point 500 for observing oil flow of the second circulation channel 315-2 or the closing cap 600 for closing the emergency branch A port 317-3 to prevent oil leakage may be coupled to the emergency branch A port 317-3. If the check point 500 is coupled, a temperature sensor or a pressure sensor may be coupled to the check point 500 to correspond to delivery of oil.

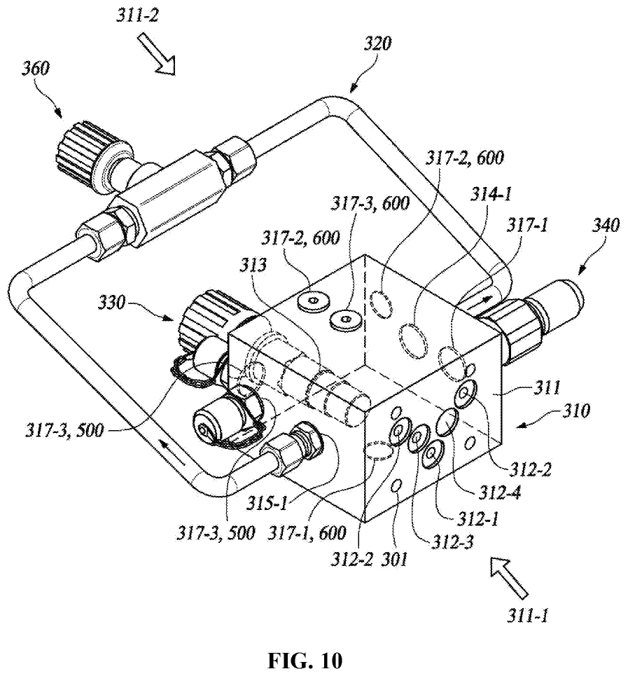

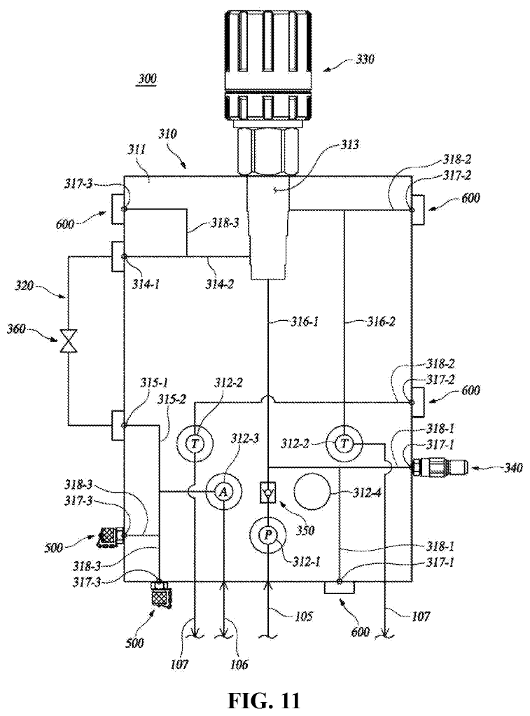

Referring to FIGS. 10 and 11, in a second example of the emergency module 300, a virtual line that sequentially connects the emergency T port 312-2, the emergency A port 312-3, the emergency P port 312-1, the emergency B port 312-4, and the emergency T port 312-2 based on the emergency 1 surface 311-1 represents a V shape. Here, in the emergency body 310, the emergency P channel 316-1 and the emergency T channel 316-2 are formed, the first circulation channel 314-2, the second circulation channel 315-2, and the circulation line 320 are formed to correspond to the A port portion of the cartridge groove 313, and a channel is not formed in the B port portion of the cartridge groove 313.

The emergency P port 312-1, the emergency P channel 316-1, and the P port portion of the cartridge groove 313 may be coaxially provided on a straight line, the emergency branch P channel 318-1 may directly branch from the emergency P channel 316-1, the emergency quick coupler 340 may be coupled to the emergency branch P port 317-1, and the emergency check member 350 may be coupled between the emergency P port 312-1 and a branchpoint of the emergency branch P channel 318-1. The emergency branch P channel 318-1 may include an emergency branch P1 channel that passes the emergency P channel 316-1 and an emergency branch P2 channel that is connected to the emergency branch P1 channel. Therefore, the emergency branch P port 317-1 may include an emergency branch P1 port to which the emergency branch P1 channel is connected and an emergency branch P2 port to which the emergency branch P2 channel is connected. Here, the emergency quick coupler 340 may be coupled to the emergency branch P2 port. The check point 500 for observing oil flow of the emergency P channel 316-1 or the closing cap 600 for closing the emergency branch P1 port to prevent oil leakage may be coupled to the emergency branch P1 port. If the check point 500 is coupled, a temperature sensor or a pressure sensor may be coupled to the check point 500.

In the second example of the emergency module 300, the emergency body 310 may include the emergency branch T channel 318-2 that connects a single pair of emergency T channels 316-2 extending from a single pair of emergency T ports 312-2 and the emergency T channel 316-2 extending from the T port portion of the cartridge groove 313 and the emergency branch T port 317-2 provided to the outer circumference of the emergency body 310 and to which the emergency branch T channel 318-2 is connected. The check point 500 for observing oil flow of the emergency T channel 316-2 or the closing cap 600 for closing the emergency branch T port 317-2 to prevent oil leakage may be coupled to the emergency branch T port 317-2. If the check point 500 is coupled, a temperature sensor or a pressure sensor may be coupled to the check point 500 to correspond to delivery of oil.

In the first example of the emergency module 300, the emergency body 310 may include the emergency branch A channel 318-3 and the emergency branch A port 317-3 provided to the outer circumference of the emergency body 310. The emergency branch A channel 318-3 may include a first branch channel that branches from the first circulation channel 314-2, a second branch channel that branches from the second circulation channel 315-2, and a third branch channel that branches from the second branch channel. Therefore, the emergency branch A port 317-3 may include a first branch port to which the first branch channel is connected, a second branch port to which the second branch channel is connected, and a third branch port to which the third branch channel is connected. The check point 500 for observing oil flow of the first circulation channel 314-2 or the second circulation channel 315-2 or the closing cap 600 for closing the emergency branch A port 317-3 to prevent oil leakage may be coupled to the emergency branch A port 317-3. If the check point 500 is coupled, a temperature sensor or a pressure sensor may be coupled to the check point 500 to correspond to delivery of oil.

An oil cleaning function according to the first method is described.

If cleaning oil is supplied through the delivery line 102 connected to the driving P1 port 212-1 in a state in which the driving P channel 214-1 and the driving A channel 214-3 are connected or in a state in which the driving P channel 214-1 and the driving B channel 214-4 are connected according to an operation of the driving control valve 220, the cleaning oil is supplied to the cylinder hydraulic chamber 111 through the driving module 200 and the operation line 103. Here, if the cylinder hydraulic chamber 111 and the dump hydraulic chamber 132 communicate with the drain chamber 170, the cleaning oil may be discharged to the drain chamber 170 and the dump oil supply line 106. Here, the cleaning oil delivered to the emergency module 300 through the dump oil supply line 106 is delivered to the drain chamber 170 through the dump drain line 107 since the emergency A port 312-3 and the emergency T channel 316-2 are connected or the emergency B port 312-4 and the emergency T channel 316-2 are connected according to an operation of the emergency control valve 330.

Also, in the case of connecting the emergency P channel 316-1 and the first circulation channel 314-2 according to an operation of the emergency control valve 330 and supplying the cleaning oil to the emergency stop line 105 that is connected to the emergency P port 312-1, the cleaning oil is delivered to the dump hydraulic chamber 132 through the emergency module 300 and the dump oil supply line 106. Therefore, the cylinder hydraulic chamber 111 and the dump hydraulic chamber 132 may be partitioned and the cleaning oil of the cylinder hydraulic chamber 111 is not directly delivered to the drain chamber 170. Here, in the case of connecting the driving A channel 214-3 and the driving T channel 214-2 or connecting the driving B channel 214-4 and the driving T channel 214-2 according to an operation of the driving control valve 220, the cleaning oil of the cylinder hydraulic chamber 111 is delivered to the drain chamber 170 through the operation line 103, the driving module 200, the return line 104, and the dump drain line 107.

The cleaning oil may be used to perform the oil cleaning function of the actuator 100 through the aforementioned circulation process.

An integrity diagnosis function according to the first method is described.

In the case of connecting the emergency P channel 316-1 and the first circulation channel 314-2 according to an operation of the emergency control valve 330 and supplying test oil to an emergency line that is connected to the emergency quick coupler 340, the test oil is delivered to the dump hydraulic chamber 132 through the emergency module 300 and the dump oil supply line 106. Therefore, the cylinder hydraulic chamber 111 and the dump hydraulic chamber 132 may be partitioned and the test oil of the cylinder hydraulic chamber 111 is not directly delivered to the drain chamber 170. Here, in the case of supplying the test oil to a driving line that is connected to the driving quick coupler 230 in a state in which the driving P channel 214-1 and the driving A channel 214-3 are connected or the driving P channel 214-1 and the driving B channel 214-4 are connected according to an operation of the driving control valve 220, the test oil may be supplied to the cylinder hydraulic chamber 111 through the driving module 200 and the operation line 103 and may move the piston. In the case of connecting the driving A channel 214-3 and the driving T channel 214-2 or connecting the driving B channel 214-4 and the driving T channel 214-2 according to an operation of the driving control valve 220, the test oil of the cylinder hydraulic chamber 111 may be delivered to the drain chamber 170 through the operation line 103, the driving module 200, the return line 104, and the dump drain line 107 and may return the piston 120 to its original position.

Here, if the emergency A port 312-3 and the emergency T channel 316-2 are connected or the emergency B port 312-4 and the emergency T channel 316-2 are connected according to an operation of the emergency control valve 330, the test oil of the dump hydraulic chamber 132 is delivered to the drain chamber 170 through the dump drain line 107 and the dump sheet 133 is moved by oil pressure of the cylinder hydraulic chamber 111 and the cylinder hydraulic chamber 111 is opened. Therefore, through communication between the cylinder hydraulic chamber 111 and the drain chamber 170 communicate, the test oil of the cylinder hydraulic chamber 111 may be quickly discharged to the drain chamber 170.

In particular, an embodiment of the present invention may perform the oil cleaning function in not only the actuator 100 but also the system line by supplying the cleaning oil through a system line of the actuator 100, and may manage a flow rate, pressure, and temperature of the test oil according to integrity diagnosis of the actuator 100 by supplying the test oil through a separate line connected to a separately provided quick coupler.

Referring to FIGS. 2 to 14, in terms of performing an oil cleaning function and an integrity diagnosis function according to a second method, an integrity diagnosis module of the actuator 100 with the oil cleaning function according to an embodiment of the present invention may include the driving module 200 and an opening and closing module 400, and may further include the emergency module 300.

The driving module 200 is coupled at a position of the driving valve 140 of the actuator 100. The driving module 200 supplies oil for the oil cleaning function of the actuator 100 or the integrity diagnosis function of the actuator 100 to the cylinder hydraulic chamber 111 provided to the actuator 100 or recovers the oil from the cylinder hydraulic chamber 111 provided to the actuator 100.

Like reference numerals refer to like components of the driving module 200 according to the second method that are same as those of the driving module 200 according to the first method and further description related thereto is omitted. Here, according to the second method, since cleaning oil or test oil is supplied from the opening and closing module 400, at least the driving quick coupler 230 may be omitted between the driving quick coupler 230 and the driving check member 240 and the check point 500 or the closing cap 600 may be coupled to the driving branch P port 215-1.

The opening and closing module 400 is coupled at a position of the opening and closing valve 150 of the actuator 100. The opening and closing module 400 selects whether to deliver the oil for the cleaning function of the actuator 100 or the integrity diagnosis function of the actuator 100 to the driving module 200.

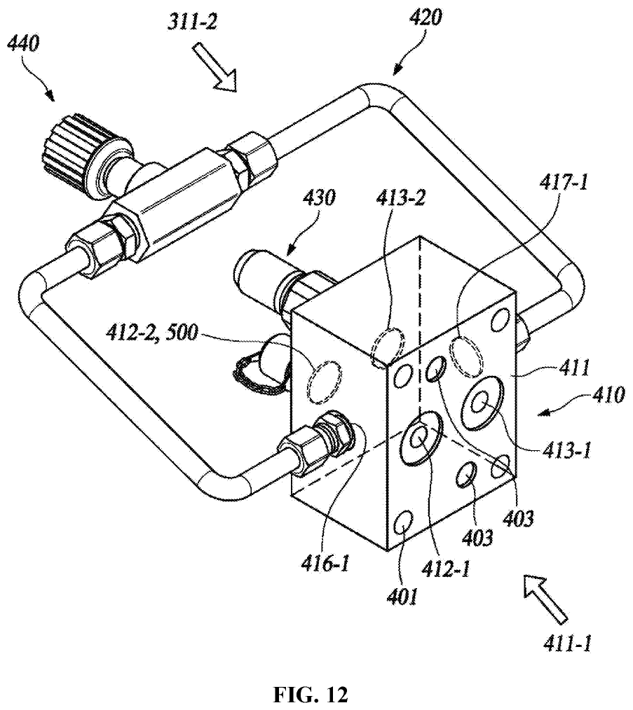

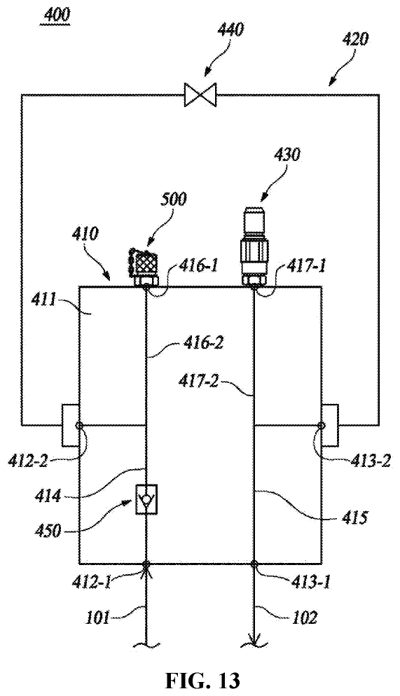

Referring to FIGS. 12 and 13, a first example of the opening and closing module 400 includes an opening and closing body 410 and an opening and closing line 420.

The opening and closing body 410 includes an opening and closing block 411 in a hexahedral shape, an opening and closing A1 port 412-1 and an opening and closing B1 port 413-1 that are spaced apart from each other on an opening and closing 1 surface 411-1 of the opening and closing block 411, an opening and closing A2 port 412-2 provided to one of an opening and closing side surface of the opening and closing block 411 connected to the opening and closing 1 surface 411-1 and an opening and closing 2 surface 411-2 of the opening and closing block 411 facing the opening and closing 1 surface 411-1, an opening and closing B2 port 413-2 provided to one of the opening and closing side surface of the opening and closing block 411 connected to the opening and closing 1 surface 411-1 and the opening and closing 2 surface 411-2 of the opening and closing block 411 facing the opening and closing 1 surface 411-1, an opening and closing A channel 414 that connects the opening and closing A1 port 412-1 and the opening and closing A2 port 412-2, and an opening and closing B channel 415 that connects the opening and closing B1 port 413-1 and the opening and closing B2 port 413-2.

Here, an opening and closing coupling groove into which a sealing ring inserts is formed in the opening and closing A1 port 412-1 and the opening and closing B1 port 413-1, thereby improving adhesion of the opening and closing body 410 at the position of the opening and closing valve 150 and preventing oil leakage in a coupling portion.

The opening and closing body 410 further includes an opening and closing branch A channel 416-2 that branches from the opening and closing A channel 414 and an opening and closing branch A port 416-1 provided to the other one of the opening and closing side surface of the opening and closing block 411 connected to the opening and closing 1 surface 411-1 and the opening and closing 2 surface 411-2 of the opening and closing block 411 facing the opening and closing 1 surface 411-1 and to which the opening and closing branch A channel 416-2 is connected. The check point 500 or the closing cap 600 is coupled to the opening and closing branch A port 416-1.

The opening and closing body 410 further includes an opening and closing branch B channel 417-2 that branches from the opening and closing B channel 415 and an opening and closing branch B port 417-1 provided to the other one of the opening and closing side surface of the opening and closing block 411 connected to the opening and closing 1 surface 411-1 and the opening and closing 2 surface 411-2 of the opening and closing block 411 facing the opening and closing 1 surface 411-1 and to which the opening and closing branch B channel 417-2 is connected.

The opening and closing 1 surface 411-1 refers to a surface that faces the position of the opening and closing valve 150 of the actuator 100, the opening and closing 2 surface 411-2 refers to a surface that faces the opening and closing 1 surface 411-1, and the opening and closing side surface refers to a surface that connects the opening and closing 1 surface 411-1 and the opening and closing 2 surface 411-2.

The first example of the opening and closing module 400 further includes an opening and closing quick coupler 430. The opening and closing quick coupler 430 couples to the opening and closing branch B port 417-1. The opening and closing quick coupler 430 has a checking function of preventing oil delivered to the opening and closing B channel 415 from flowing back toward the opening and closing branch B port 417-1. Since a separate driving line is coupled to the opening and closing quick coupler 430, test oil may be supplied to the driving body 210 even after omitting the driving quick coupler 230 of the driving module 200.

Next, the oil that is supplied to the driving module 200 may be supplied from the opening and closing A1 port 412-1 or the opening and closing quick coupler 430.

The first example of the opening and closing module 400 further includes at least one of a line valve 440 and an opening and closing check member 450.

The line valve 440 may be provided on the opening and closing line 420 and may select whether to deliver oil or may control a delivery rate of the oil in the opening and closing line 420. The line valve 440 may be manually controllable as a hand type or a dial valve type or may be automatically controllable as a solenoid type.

The opening and closing check member 450 is provided in a direction from the opening and closing A1 port 412-1 to the opening and closing A channel 414 based on the opening and closing quick coupler 430. The opening and closing check member 450 may prevent the oil delivered to the opening and closing B channel 415 from flowing back toward the opening and closing A1 port 412-1 and may simplify repair and maintenance of the opening and closing check member 450 on a side of the opening and closing A1 port 412-1.

A not-described reference numeral 401 refers to an opening and closing coupling portion that is formed in a penetrating form in the opening and closing body 410 to couple the opening and closing body 410 at the position of the opening and closing valve 150 of the actuator 100, and a not-described reference numeral 403 refers to an opening and closing pilot port that is formed on the opening and closing 1 surface 411-1 to correspond to a pilot port of the opening and closing valve 150. An opening and closing pilot coupling groove into which a sealing ring inserts is formed in the opening and closing pilot port 403, thereby improving adhesion of the opening and closing body 410 at the position of the opening and closing valve 150 and preventing oil leakage in a coupling portion.

Here, describing an oil cleaning function according to the second method, if cleaning oil is supplied to the opening and closing A1 port 412-1 to which the hydraulic signal line 101 is connected and the line valve 440 is opened, the cleaning oil is supplied to the delivery line 102 through the opening and closing A channel 414, the line valve 440, and the opening and closing B channel 415, and performs the oil cleaning function.

Also, describing an integrity diagnosis function according to the second method, if test oil is supplied to the opening and closing quick coupler 430 to which the driving line is connected and the line valve 440 is closed, the test oil is supplied to the delivery line 102 through the opening and closing B channel 415 and performs the integrity diagnosis function.

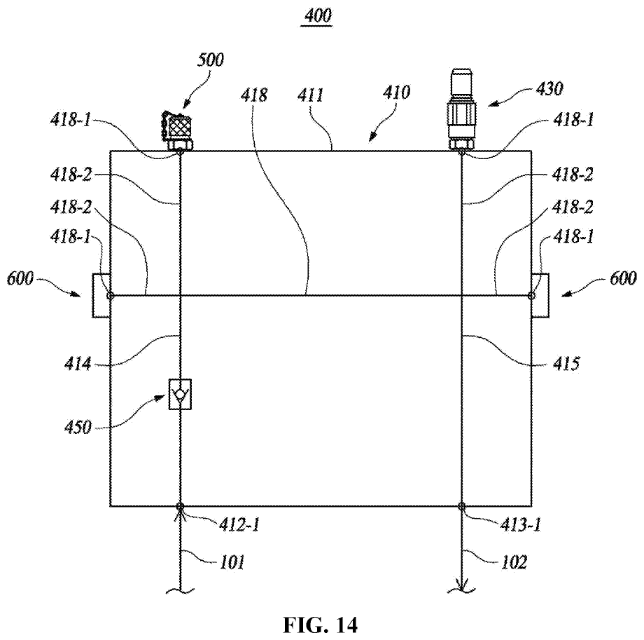

Referring to FIG. 14, a second example of the opening and closing module 400 includes the opening and closing body 410.

The second example of the opening and closing module 400 may be configured more compactly than the first example of the opening and closing module 400, thereby contributing to miniaturization of a module.

The opening and closing body 410 includes the opening and closing block 411 in a hexahedral shape, the opening and closing A1 port 412-1 and the opening and closing B1 port 413-1 that are spaced apart from each other on the opening and closing 1 surface 411-1 of the opening and closing block 411, the opening and closing A channel 414 that is connected to the opening and closing A1 port 412-1, the opening and closing B channel 415 that is connected to the opening and closing B1 port 413-1, and an connection channel 418 that connects the opening and closing A channel 414 and the opening and closing B channel 415.

Here, an opening and closing coupling groove into which a sealing ring inserts is formed in the opening and closing A1 port 412-1 and the opening and closing B1 port 413-1, thereby improving adhesion of the opening and closing body 410 at the position of the opening and closing valve 150 and preventing oil leakage in a coupling portion.

The opening and closing body 410 further includes an opening and closing branch channel 418-2 that branches from one of the opening and closing A channel 414 and the opening and closing B channel 415 and an opening and closing branch port 418-1 provided to one of the opening and closing side surface of the opening and closing block 411 connected to the opening and closing 1 surface 411-1 and the opening and closing 2 surface 411-2 of the opening and closing 1 surface 411-1 facing the opening and closing block 411 and to which the opening and closing branch channel 418-2 is connected.

The second example of the opening and closing module 400 further includes the opening and closing quick coupler 430 coupled to the opening and closing branch port 418-1 and configured to prevent the oil delivered to the opening and closing B channel 415 from flowing back toward the opening and closing branch port 418-1. The check point 500 or the closing cap 600 is coupled to the open opening and closing branch port 418-1.

Next, the oil that is supplied to the driving module 200 may be supplied from the opening and closing A1 port 412-1 or the opening and closing quick coupler 430.

The second example of the opening and closing module 400 further includes the opening and closing check member 450 provided to the side of the opening and closing A1 port 412-1 based on the opening and closing quick coupler 430 and configured to prevent the oil delivered to the opening and closing B channel 415 from flowing back toward the opening and closing A1 port 412-1.

The emergency module 300 couples at the position of the emergency stop valve 160 of the actuator 100. The emergency module 300 supplies oil for the cleaning function of the actuator 100 or the integrity diagnosis function of the actuator 100 to the dump hydraulic chamber 132 provided to the actuator 100 or recovers the oil from the dump hydraulic chamber 132 provided to the actuator 100.

The emergency module 300 is configured in the same manner as the emergency module 300 of the aforementioned diagnosis module in terms of performing the oil cleaning function and the integrity diagnosis function according to the first method and thus, further description related thereto is omitted.

Here, describing the oil cleaning function according to the second method, if the cleaning oil is supplied to the opening and closing A1 port 412-1 to which the hydraulic signal line 101 is connected, the cleaning oil is supplied to the delivery line 102 through the opening and closing A channel 414, the line valve 440, and the opening and closing B channel 415 and performs the oil cleaning function, without flowing back toward the opening and closing A1 port 412-1 and the opening and closing quick coupler 430.

Also, describing the integrity diagnosis function according to the second method, if the test oil is supplied to the opening and closing quick coupler 430 to which the driving line is connected, the test oil is supplied to the delivery line 102 through the opening and closing B channel 415 and performs the integrity diagnosis function, without flowing back toward the driving quick coupler 230 and the opening and closing A1 port 412-1.

Also, in the second method, an operation of the emergency module 300 is replaced with an operation of the emergency module 300 according to the first method.

In the aforementioned description, the hydraulic oil refers to oil that is supplied for driving of the actuator 100, the cleaning oil refers to oil that is supplied for the cleaning function of the actuator 100, and the test oil refers to oil that is supplied for integrity diagnosis of the actuator 100.

As described above, although example embodiments of the present invention are described with reference to the accompanying drawings, it will be apparent to those skilled in the art that various modifications or alterations may be made to the present invention without departing from the spirit and scope of the present invention described in the claims.

What is claimed is:

1. An integrity diagnosis module of an actuator with an oil cleaning function, comprising at least one of:
a driving module coupled at a driving valve position of the actuator and configured to supply an oil for a cleaning function of the actuator or an integrity diagnosis function of the actuator to a cylinder hydraulic chamber provided to the actuator or to recover the oil from the cylinder hydraulic chamber provided to the actuator; and
an emergency module coupled at an emergency stop valve position of the actuator and configured to supply the oil to a dump hydraulic chamber provided to the actuator or to recover the oil from the dump hydraulic chamber provided to the actuator.

2. The integrity diagnosis module of claim 1, wherein the driving module comprises:
a driving body comprising:
a driving block in a hexahedral shape,
at least one of a driving A1 port and a driving B1 port spaced apart from each other on a driving 1 surface of the driving block,
a driving P1 port and a driving T1 port,
at least one of a driving A2 port and a driving B2 port spaced apart from each other on a driving 2 surface of the driving block facing the driving 1 space,
a driving P2 port and a driving T2 port,
at least one of a driving A channel and a driving B channel, the driving A channel connecting the driving A1 port and the driving A2 port, and the driving B channel connecting the driving B1 port and the driving B2 port,
a driving P channel connecting the driving P1 port and the driving P2 port, and
a driving T channel connecting the driving T1 port and the driving T2 port; and
a driving control valve coupled to the driving 2 surface and configured to deliver the oil delivered to the driving P2 port to the driving A2 port or the driving B2 port, or to deliver the oil delivered to the driving A2 port or the driving B2 port to the driving T2 port,
wherein the driving body further comprises a driving branch P channel and a driving branch P port, the driving branch P channel branching from the driving P channel, the driving branch P port being provided to an outer circumference of the driving body, wherein the driving branch P channel is connected to the driving branch P port,
wherein the driving module further comprises a driving quick coupler coupled to the driving branch P port and configured to prevent the oil delivered to the driving P channel from flowing back toward the driving branch P port, and
wherein the oil supplied to the cylinder hydraulic chamber is supplied from the driving P1 port or the driving quick coupler.

3. An integrity diagnosis module of an actuator with an oil cleaning function, comprising:
a driving module coupled at a driving valve position of the actuator and configured to supply an oil for a cleaning function of the actuator or an integrity diagnosis function of the actuator to a cylinder hydraulic chamber of the actuator or to recover the oil from the cylinder hydraulic chamber provided to the actuator; and
an opening and closing module coupled at an opening and closing valve position of the actuator and configured to determine whether to deliver the oil to the driving module.

4. The integrity diagnosis module of claim 3, wherein the opening and closing module comprises:
an opening and closing body comprising:
an opening and closing block in a hexahedral shape,
an opening and closing A1 port and an opening and closing B1 port spaced apart from each other on an opening and closing 1 surface of the opening and closing block,
an opening and closing A2 port provided to one of an opening and closing side surface of the opening and closing block connected to the opening and closing 1 surface and an opening and closing 2 surface of the opening and closing block facing the opening and closing 1 surface,
an opening and closing B2 port provided to one of the opening and closing side surface of the opening and closing block connected to the opening and closing 1 surface and the opening and closing 2 surface of the opening and closing block facing the opening and closing 1 surface,
an opening and closing A channel connecting the opening and closing A1 port and the opening and closing A2 port, and
an opening and closing B channel connecting the opening and closing B1 port and the opening and closing B2 port; and
an opening and closing line configured to connect the opening and closing A2 port and the opening and closing B2 port,
wherein the opening and closing body further comprises:
an opening and closing branch B channel branching from the opening and closing B channel, and
an opening and closing branch B port provided to the other one of the opening and closing side surface of the opening and closing block connected to the opening and closing 1 surface and the opening and closing 2 surface of the opening and closing block facing the opening and closing 1 surface, wherein the opening and closing branch B channel is connected to the opening and closing branch B port,
wherein the opening and closing module further comprises an opening and closing quick coupler coupled to the opening and closing branch B port and configured to prevent the oil delivered to the opening and closing B channel from flowing back toward the opening and closing branch B port, and
wherein the oil supplied to the driving module is supplied from the opening and closing A1 port or the opening and closing quick coupler.

5. The integrity diagnosis module of claim 3, wherein the opening and closing module comprises:
an opening and closing body comprising:
an opening and closing block in a hexahedral shape,
an opening and closing A1 port and an opening and closing B1 port spaced apart from each other on an opening and closing 1 surface of the opening and closing block,
an opening and closing A channel connected to the opening and closing A1 port,
an opening and closing B channel connected to the opening and closing B1 port, and
a connection channel connecting the opening and closing A channel and the opening and closing B channel,
wherein the opening and closing body further comprises:
an opening and closing branch channel branching from one of the opening and closing A channel, the opening and closing B channel, and the connection channel, and
an opening and closing branch port provided to one of an opening and closing side surface of the opening and closing block connected to the opening and closing 1 surface and an opening and closing 2 surface of the opening and closing block facing the opening and closing 1 surface, wherein the opening and closing branch channel is connected to the opening and closing branch port,
wherein the opening and closing module further comprises an opening and closing quick coupler coupled to the opening and closing branch port and configured to prevent the oil delivered to the opening and closing B channel from flowing back toward the opening and closing branch port, and
wherein the oil supplied to the driving module is supplied from the opening and closing A1 port or the opening and closing quick coupler.

6. The integrity diagnosis module of claim 3, wherein the driving module comprises:
a driving body comprising:
a driving block in a hexahedral shape,
at least one of a driving A1 port and a driving B1 port spaced apart from each other on a driving 1 surface of the driving block,
a driving P1 port and a driving T1 port,
at least one of a driving A2 port and a driving B2 port spaced apart from each other on a driving 2 surface of the driving block facing the driving 1 surface,
a driving P2 port and a driving T2 port,
at least one of a driving A channel and a driving B channel, the driving A channel connecting the driving A1 port and the driving A2 ports, and the driving B channel connecting the driving B1 port and the driving B2 port,
a driving P channel connecting the driving P1 port and the driving P2 port, and
a driving T channel connecting the driving T1 port and the driving T2 port; and
a driving control valve configured to deliver the oil delivered to the driving P2 port to the driving A2 port or the driving B2 port, or to deliver the oil delivered to the driving A2 port or the driving B2 port to the driving T2 port,
wherein the oil delivered to the cylinder hydraulic chamber is delivered from the opening and closing module and supplied from the driving P1 port.

7. The integrity diagnosis module of claim 2, wherein the driving module further comprises a driving check member provided to the driving P channel and configured to prevent the oil delivered to the driving P channel from flowing back toward the driving P1 port.

8. The integrity diagnosis module of claim 3, further comprising:
an emergency module coupled at an emergency stop valve position of the actuator and configured to supply the oil or recover the oil based on a dump chamber side provided to the actuator.

9. The integrity diagnosis module of claim 1, wherein the emergency module comprises:
an emergency body comprising:
an emergency block in a hexahedral shape,
at least one of an emergency A port and an emergency B port spaced apart from each other on an emergency 1 surface of the emergency block,
an emergency P port and an emergency T port,
a cartridge groove formed in a recessed form on an emergency 2 surface of the emergency block facing the emergency 1 surface in correspondence to the emergency P port,
a first circulation port and a second circulation port spaced apart from each other on an outer circumference of the emergency block,
a first circulation channel branching from an A port portion of the cartridge groove or a B port portion of the cartridge groove and connected to the first circulation port,
a second circulation channel connecting the second circulation port and the emergency A port or connecting the second circulation port and the emergency B port,
an emergency P channel connecting the emergency P port and a P port portion of the cartridge groove, and
an emergency T channel branching from a T port portion of the cartridge groove and connected to the emergency T port;
a circulation line configured to connect a first circulation path and a second circulation path for a communication between the A port portion and the emergency A port or for a communication between the B port portion and the emergency B port; and
an emergency control valve inserted into and thereby coupled to the cartridge groove and configured to deliver the oil delivered to the emergency P channel to the first circulation channel or to deliver the oil delivered to the second circulation channel to the emergency T channel,
wherein the emergency body further comprises an emergency branch P channel branching from the emergency P channel and an emergency branch P port provided to an outer circumference of the emergency body, wherein the emergency branch P channel is connected to the emergency branch P port,
wherein the emergency module further comprises an emergency quick coupler coupled to the emergency branch P port and configured to prevent the oil delivered to the P port portion of the cartridge groove from flowing back toward the emergency branch P port, and
wherein the oil supplied to the dump hydraulic chamber is supplied from the emergency P port or the emergency quick coupler.

10. The integrity diagnosis module of claim 9, wherein the emergency module further comprises an emergency check member provided to the emergency P channel and configured to prevent the oil delivered to the emergency P channel from flowing back toward the emergency P port.
